(19) United States
(12) Patent Application Publication
(10) Pub. No.: US 2025/0017224 A1
(43) Pub. Date: Jan. 16, 2025

(54) CONSUMER APPLICATIONS FOR CYCLOPROPENE-CONTAINING COMPOSITIONS

(71) Applicant: AGROFRESH INC., Philadelphia, PA (US)

(72) Inventors: Lei LIU, Philadelphia, PA (US); Duncan AUST, Philadelphia, PA (US); Daniel MACLEAN, Philadelphia, PA (US); Evan MCCASKEY, Philadelphia, PA (US); Fiona WEHMEYER, Philadelphia, PA (US)

(21) Appl. No.: 18/711,752

(22) PCT Filed: Nov. 22, 2022
(86) PCT No.: PCT/US2022/050667

§ 371 Date: May 20, 2024

Related U.S. Application Data
(60) Provisional application No. 63/282,942, filed on Nov. 24, 2021.

(51) Int. Cl. A23B 7/152; A01N 3/00; A01N 27/00

(52) U.S. Cl. CPC A23B 7/152; A01N 3/00; A01N 27/00

(57) ABSTRACT

The present disclosure provides methods of treating a mixed type of produce with a cyclopropene, as well as methods of treating plant or plant parts in an environment comprising exogenous ethylene methods with a cyclopropene. The methods described herein exhibit desirable properties and provide related advantages to benefit the quality and extend the freshness of produce and also reduce waste associated with the over-ripening of produce.

### CROSS-REFERENCE TO RELATED APPLICATIONS

This application claims the benefit of U.S. Provisional Patent Application No. 63/282,942, filed Nov. 24, 2022, the entire disclosure of which is hereby incorporated by reference.

### TECHNICAL FIELD

The invention relates to methods of treating a mixed type of produce with a cyclopropene. The invention also relates to methods of treating plant or plant parts in an environment comprising exogenous ethylene.

### BACKGROUND AND SUMMARY OF THE INVENTION

The presence of produce is a common sight in most refrigerators around the world. For example, produce can be found in the household refrigerators of most consumers as well as in industrial distribution centers, retailers, and restaurants. Further, the produce is typically present in the refrigerators in mixed types such that more than one type of produce can be found in the refrigerator at any given time. For instance, several different types of produce can be present as a mixed type in a single enclosure inside a refrigerator.

It is well known that produce exposed to exogenous ethylene results in ripening or undesired aging of the produce. For instance, exposure of produce to ethylene results in increased ripening of the produce, thus reducing the freshness of the produce. Furthermore, it is known the sensitivity of different types of produce to exogenous ethylene vary widely.

Importantly, produce itself gives off endogenous ethylene. However, the endogenous production of ethylene by different types of produce also varies widely. When several different types of produce are present as a mixed type in an enclosure, the various types of produce will give off endogenous ethylene at different rates.

One problem facing consumers that store a mixed type of different types of produce in an enclosure is the unpredictable ripening or undesired aging of the various produce. First, the different types of produce in the enclosure each have varying sensitivities to exogenous ethylene, resulting in uneven ripening or undesired aging of the types of produce in the enclosure. Second, the different types of produce in the enclosure each have different levels of endogenous ethylene production given off by the produce itself. As a result, a single enclosure including a variety of produce can present a challenging environment for the different types of produce to remain fresh for consumption. Thus, there is exists a need for consumers to be able to store different types of produce in an enclosure in which the produce can preserve quality and extend freshness.

Accordingly, the present disclosure provides methods of treating a mixed type of produce with a cyclopropene, as well as methods of treating plant or plant parts in an environment comprising exogenous ethylene methods with a cyclopropene. The methods described herein exhibit desirable properties and provide related advantages to benefit the quality and extend the freshness of produce and also reduce waste associated with the over-ripening or undesired aging of produce. For instance, when the mixed type of produce comprises fresh produce and over-ripened and/or aged produce, the cyclopropene can provide a preserving and/or extending quality of the fresh produce even in the presence of over-ripened and/or aged produce. Further, when the mixed type of produce comprises non-climacteric produce and climacteric produce, the cyclopropene can provide a preserving and/or extending quality of the non-climacteric produce even in the presence of climacteric produce. Finally, when the mixed type of produce comprises fresh produce and high ethylene-emitting produce, the cyclopropene can provide a preserving and/or extending quality of the fresh produce even in the presence of high ethylene-emitting produce.

Other objects, features and advantages of the present disclosure will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 shows an evaluation performed on day 6 comparing the 1-MCP treated versus the control bananas.

FIG. 2 shows an evaluation performed on day 10 comparing the 1-MCP treated versus the control tomatoes.

FIG. 3 shows an evaluation performed on day 10 comparing the 1-MCP treated versus the control tomatoes.

FIG. 4 shows an evaluation performed on day 7 of control avocados.

FIG. 5 shows an evaluation performed on day 7 of 1-MCP treated avocados.

FIG. 6 shows an evaluation performed on day 7 comparing the 1-MCP treated versus the control bananas.

FIG. 7 shows an evaluation comparing the 1-MCP treated versus the control green bell peppers.

FIG. 8 shows an evaluation comparing the 1-MCP treated versus the control papayas.

FIG. 9 shows an evaluation performed on day 6 comparing the 1-MCP treated versus the control bananas and avocados.

FIG. 10 shows a second evaluation performed on day 8 comparing the internal condition of the 1-MCP treated avocados.

FIG. 11 shows a second evaluation performed on day 8 comparing the internal condition of the control avocados.

FIG. 12 shows an evaluation performed on day 17 comparing the 1-MCP treated versus the control bananas.

FIG. 13 shows an evaluation performed on day 21 comparing the 1-MCP treated versus the control bananas.

FIG. 14 shows an evaluation performed on day 14 comparing the 1-MCP treated versus the control bananas.

FIG. 15 shows an evaluation performed on day 7 comparing the 1-MCP treated versus the control bananas.

FIG. 16 shows an evaluation performed on day 6 comparing the 1-MCP treated versus the control bananas.

FIG. 17 shows an evaluation performed on day 2 comparing the 1-MCP treated pears versus the control pears.

FIG. 18 shows an evaluation performed on day 2 comparing the 1-MCP treated strawberries versus the control strawberries.

FIG. 19 shows an evaluation performed on day 4 of the control produce.

FIG. 20 shows an evaluation performed on day 4 of the 1-MCP treated produce.

FIG. 21 shows an evaluation performed on day 2 comparing the 1-MCP treated versus the control broccoli.

FIG. 22 shows results of a second evaluation performed on day 10 comparing the 1-MCP treated versus the control blueberries.

FIG. 23 shows results of a second evaluation performed on day 10 comparing the 1-MCP treated versus the control kiwi.

FIG. 24 shows an evaluation performed on day 2 comparing the 1-MCP treated versus the control apples.

FIG. 25 shows an evaluation performed on day 6 comparing the 1-MCP treated versus the control apples.

FIG. 26 shows an evaluation performed on day 1 comparing the 1-MCP treated versus the control apples.

FIG. 27 shows an evaluation performed on day 6 comparing the 1-MCP treated versus the control apples.

FIG. 28 shows an evaluation performed on day 9 comparing the 1-MCP treated versus the control bananas.

FIG. 29 shows an evaluation performed on day 4 comparing the 1-MCP treated versus the control bananas.

FIG. 30 shows an evaluation performed on day 7 comparing the 1-MCP treated versus the control bananas.

FIG. 31 shows an evaluation performed on day 4 comparing the 1-MCP treated versus the control bananas.

FIG. 32 shows an evaluation performed on day 7 comparing the 1-MCP treated versus the control bananas.

### DETAILED DESCRIPTION

The following numbered embodiments are contemplated and are non-limiting:
1. A method of treating a mixed type of produce, said method comprising the step of administering a composition comprising a cyclopropene to the mixed type of produce.
2. The method of clause 1, any other suitable clause, or any combination of suitable clauses, wherein the mixed type of produce comprises one or more fruits.
3. The method of clause 1, any other suitable clause, or any combination of suitable clauses, wherein the mixed type of produce comprises one or more vegetables.
4. The method of clause 1, any other suitable clause, or any combination of suitable clauses, wherein the mixed type of produce comprises one or more fruits and one or more vegetables.
5. The method of clause 1, any other suitable clause, or any combination of suitable clauses, wherein the mixed type of produce comprises produce selected from the group consisting of apple, apricot, artichoke, asparagus, avocado, banana, blackberry, blueberry, broccoli, cantaloupe, carrot, cauliflower, celery, cherimoya, cherry, sweet cherry, sour cherry, cucumber, eggplant, fig, grape, grapefruit, guava, honeydew, kiwifruit, lemon, lettuce, butterhead lettuce, iceberg lettuce, lima bean, lime, mango, mushroom, nectarine, onion, dry onion, green onion, orange, papaya, peach, pear, Asian pear, Anjou pear, Bartlett pear, Bose pear, prickly pear, bell pepper, chili pepper, persimmon, Fuyo persimmon, Hachiya persimmon, pineapple, plum, pomegranate, potato, pumpkin, radish, snap bean, spinach, squash, strawberry, sweet corn, sweet potato, tomato, watermelon, zucchini, Belgian Endive, cranberry, currents, dewberry, elderberry, gooseberry, Cape gooseberry, Chinese gooseberry, loganberry, raspberry, breadfruit, broccoli, Brussel sprout, cabbage, casaba melon, chard, collards, Crenshaw melon, endive (escarole), feijoa, garlic, ginger, horseradish, jack fruit, kale, kohirabi, leek, lychee, mandarine, mangosteen, mincola, nectarine, okra, paprika, parsley, parsnip, passion fruit, pea, Persian melon, plantain, pomegranate, quince, red beet, rambutan, rhubarb, rutabaga, sapota, star fruit, tamarillo, tangerine, taro root, turnip, watercress, yam, and any combination thereof.
6. The method of clause 1, any other suitable clause, or any combination of suitable clauses, wherein the mixed type of produce comprises fresh cut produce, sliced produce, ready-to-eat produce, read-to-serve produce, or any combination thereof.
7. The method of clause 1, any other suitable clause, or any combination of suitable clauses, wherein the mixed type of produce comprises a fresh cut plant or plant parts.
8. The method of clause 7, any other suitable clause, or any combination of suitable clauses, wherein the fresh cut plant or plant parts comprise a Christmas tree.
9. The method of clause 7, any other suitable clause, or any combination of suitable clauses, wherein the fresh cut plant or plant parts comprise a nursery plant.
10. The method of clause 7, any other suitable clause, or any combination of suitable clauses, wherein the fresh cut plant or plant parts comprise one or more cut flowers.
11. The method of clause 10, any other suitable clause, or any combination of suitable clauses, wherein the flowers comprise roses.
12. The method of clause 10, any other suitable clause, or any combination of suitable clauses, wherein the flowers comprise chrysanthemums.
13. The method of clause 10, any other suitable clause, or any combination of suitable clauses, wherein the flowers comprise gladioli.
14. The method of clause 10, any other suitable clause, or any combination of suitable clauses, wherein the flowers comprise carnations.
15. The method of clause 1, any other suitable clause, or any combination of suitable clauses, wherein the mixed type of produce comprises one or more flower bulbs.
16. The method of clause 15, any other suitable clause, or any combination of suitable clauses, wherein the flower bulbs are selected from the group consisting of bulbs, corns, rhizomes, tubers, and any combination thereof.
17. The method of clause 1, any other suitable clause, or any combination of suitable clauses, wherein the mixed type of produce comprises produce is present in an enclosed space or a partially enclosed space.
18. The method of clause 17, any other suitable clause, or any combination of suitable clauses, wherein the enclosed space/partially enclosed space is a refrigerator.
19. The method of clause 17, any other suitable clause, or any combination of suitable clauses, wherein the enclosed space/partially enclosed space is a household refrigerator.
20. The method of clause 17, any other suitable clause, or any combination of suitable clauses, wherein the enclosed space/partially enclosed space is an industrial distribution center refrigerator.
21. The method of clause 17, any other suitable clause, or any combination of suitable clauses, wherein the enclosed space/partially enclosed space is a retailor refrigerator.
22. The method of clause 17, any other suitable clause, or any combination of suitable clauses, wherein the enclosed space/partially enclosed space is a transport refrigerator.
23. The method of clause 17, any other suitable clause, or any combination of suitable clauses, wherein the enclosed space/partially enclosed space comprises a source of exogenous ethylene.
24. The method of clause 23, any other suitable clause, or any combination of suitable clauses, wherein the source of exogenous ethylene is present in the enclosed space/partially enclosed space via one or more items in the mixed type of produce.
25. The method of clause 23, any other suitable clause, or any combination of suitable clauses, wherein the source of exogenous ethylene is present in the enclosed space/partially enclosed space via a household item.
26. The method of clause 25, any other suitable clause, or any combination of suitable clauses, wherein the household item is a stove.
27. The method of clause 25, any other suitable clause, or any combination of suitable clauses, wherein the household item is a propane-containing composition.
28. The method of clause 17, any other suitable clause, or any combination of suitable clauses, wherein the composition comprising the cyclopropene is placed in the enclosed space/partially enclosed space.
29. The method of clause 1, any other suitable clause, or any combination of suitable clauses, wherein the cyclopropene is 1-MCP.
30. The method of clause 1, any other suitable clause, or any combination of suitable clauses, wherein the composition comprising the cyclopropene comprises an activated carbon.
31. The method of clause 1, any other suitable clause, or any combination of suitable clauses, wherein the composition comprising the cyclopropene comprises a metal organic framework.
32. The method of clause 1, any other suitable clause, or any combination of suitable clauses, wherein the composition comprising the cyclopropene comprises a molecular encapsulating agent.
33. The method of clause 1, any other suitable clause, or any combination of suitable clauses, wherein the composition comprising the cyclopropene comprises porous silica.
34. The method of clause 1, any other suitable clause, or any combination of suitable clauses, wherein the composition comprising the cyclopropene comprises a sachet.
35. The method of clause 1, any other suitable clause, or any combination of suitable clauses, wherein the composition comprising the cyclopropene comprises a film.
36. The method of clause 1, any other suitable clause, or any combination of suitable clauses, wherein the composition comprising the cyclopropene comprises a card.
37. The method of clause 1, any other suitable clause, or any combination of suitable clauses, wherein the composition comprising the cyclopropene comprises a card coated with the cyclopropene.
38. The method of clause 1, any other suitable clause, or any combination of suitable clauses, wherein the composition comprising the cyclopropene comprises a sticker.
39. The method of clause 1, any other suitable clause, or any combination of suitable clauses, wherein the composition comprising the cyclopropene comprises a sticker coated with the cyclopropene.
40. The method of clause 1, any other suitable clause, or any combination of suitable clauses, wherein the composition comprising the cyclopropene comprises an insert.
41. The method of clause 1, any other suitable clause, or any combination of suitable clauses, wherein the composition comprising the cyclopropene comprises an insert coated with the cyclopropene.
42. The method of clause 1, any other suitable clause, or any combination of suitable clauses, wherein the composition comprising the cyclopropene comprises a label.
43. The method of clause 1, any other suitable clause, or any combination of suitable clauses, wherein the composition comprising the cyclopropene comprises a label coated with the cyclopropene.
44. The method of clause 1, any other suitable clause, or any combination of suitable clauses, wherein the composition comprising the cyclopropene comprises a packaging.
45. The method of clause 1, any other suitable clause, or any combination of suitable clauses, wherein the composition comprising the cyclopropene comprises a packaging coated with the cyclopropene.
46. The method of clause 1, any other suitable clause, or any combination of suitable clauses, wherein the composition comprising the cyclopropene is configured to release the cyclopropene under humidity.
47. The method of clause 1, any other suitable clause, or any combination of suitable clauses, wherein the composition comprising the cyclopropene comprises a spray.
48. The method of clause 1, any other suitable clause, or any combination of suitable clauses, wherein the composition comprising the cyclopropene comprises an aerosol can.
49. The method of clause 1, any other suitable clause, or any combination of suitable clauses, wherein the composition comprising the cyclopropene comprises a caulk gun.
50. The method of clause 1, any other suitable clause, or any combination of suitable clauses, wherein the composition comprising the cyclopropene comprises a marker.
51. The method of clause 1, any other suitable clause, or any combination of suitable clauses, wherein the composition comprising the cyclopropene comprises a paint brush.
52. The method of clause 1, any other suitable clause, or any combination of suitable clauses, wherein the composition comprising the cyclopropene comprises a stick.
53. The method of clause 1, any other suitable clause, or any combination of suitable clauses, wherein the composition comprising the cyclopropene comprises a chalk.
54. The method of clause 1, any other suitable clause, or any combination of suitable clauses, wherein the composition comprising the cyclopropene comprises a bag.
55. The method of clause 1, any other suitable clause, or any combination of suitable clauses, wherein the composition comprising the cyclopropene comprises a can comprising a bladder, wherein the cyclopropene is present inside the bladder.
56. The method of clause 1, any other suitable clause, or any combination of suitable clauses, wherein the method is associated with an improved quality of the mixed type of produce.
57. The method of clause 1, any other suitable clause, or any combination of suitable clauses, wherein the method is associated with a longer duration of freshness of the mixed type of produce.
58. The method of clause 1, any other suitable clause, or any combination of suitable clauses, wherein the method is associated with a reduction of waste for the mixed type of produce.
59. The method of clause 1, any other suitable clause, or any combination of suitable clauses, wherein the mixed type of produce comprises fresh produce and over-ripened and/or aged produce.
60. The method of clause 59, any other suitable clause, or any combination of suitable clauses, wherein the cyclopropene provides a preserving and/or extending quality of the fresh produce.
61. The method of clause 1, any other suitable clause, or any combination of suitable clauses, wherein the mixed type of produce comprises non-climacteric produce and climacteric produce.
62. The method of clause 61, any other suitable clause, or any combination of suitable clauses, wherein the cyclopropene provides a preserving and/or extending quality of the non-climacteric produce.
63. The method of clause 61, any other suitable clause, or any combination of suitable clauses, wherein the non-climacteric produce is fresh produce.
64. The method of clause 1, any other suitable clause, or any combination of suitable clauses, wherein the mixed type of produce comprises fresh produce and high ethylene-emitting produce.
65. The method of clause 64, any other suitable clause, or any combination of suitable clauses, wherein the cyclopropene provides a preserving and/or extending quality of the fresh produce.
66. A method of treating plant or plant parts in an environment comprising exogenous ethylene, said method comprising the step of administering a composition comprising a cyclopropene to the produce.
67. The method of clause 66, any other suitable clause, or any combination of suitable clauses, wherein the plant or plant parts comprise produce.
68. The method of clause 67, any other suitable clause, or any combination of suitable clauses, wherein the produce comprises a mixed type of produce.
69. The method of clause 68, any other suitable clause, or any combination of suitable clauses, wherein the mixed type of produce comprises one or more fruits.
70. The method of clause 68, any other suitable clause, or any combination of suitable clauses, wherein the mixed type of produce comprises one or more vegetables.
71. The method of clause 68, any other suitable clause, or any combination of suitable clauses, wherein the mixed type of produce comprises one or more fruits and one or more vegetables.
72. The method of clause 68, any other suitable clause, or any combination of suitable clauses, wherein the mixed type of produce comprises produce selected from the group consisting of apple, apricot, artichoke, asparagus, avocado, banana, blackberry, blueberry, broccoli, cantaloupe, carrot, cauliflower, celery, cherimoya, cherry, sweet cherry, sour cherry, cucumber, eggplant, fig, grape, grapefruit, guava, honeydew, kiwifruit, lemon, lettuce, butterhead lettuce, iceberg lettuce, lima bean, lime, mango, mushroom, nectarine, onion, dry onion, green onion, orange, papaya, peach, pear, Asian pear, Anjou pear, Bartlett pear, Bose pear, prickly pear, bell pepper, chili pepper, persimmon, Fuyo persimmon, Hachiya persimmon, pineapple, plum, pomegranate, potato, pumpkin, radish, snap bean, spinach, squash, strawberry, sweet corn, sweet potato, tomato, watermelon, zucchini, Belgian Endive, cranberry, currents, dewberry, elderberry, gooseberry, Cape gooseberry, Chinese gooseberry, loganberry, raspberry, breadfruit, broccoli, Brussel sprout, cabbage, casaba melon, chard, collards, Crenshaw melon, endive (escarole), feijoa, garlic, ginger, horseradish, jack fruit, kale, kohirabi, leek, lychee, mandarine, mangosteen, mincola, nectarine, okra, paprika, parsley, parsnip, passion fruit, pea, Persian melon, plantain, pomegranate, quince, red beet, rambutan, rhubarb, rutabaga, sapota, star fruit, tamarillo, tangerine, taro root, turnip, watercress, yam, and any combination thereof.
73. The method of clause 68, any other suitable clause, or any combination of suitable clauses, wherein the mixed type of produce comprises fresh cut produce, sliced produce, ready-to-eat produce, read-to-serve produce, or any combination thereof.
74. The method of clause 66, any other suitable clause, or any combination of suitable clauses, wherein the plant or plant parts comprise a fresh cut plant or plant parts.
75. The method of clause 74, any other suitable clause, or any combination of suitable clauses, wherein the fresh cut plant or plant parts comprise a Christmas tree.
76. The method of clause 74, any other suitable clause, or any combination of suitable clauses, wherein the fresh cut plant or plant parts comprise a nursery plant.
77. The method of clause 74, any other suitable clause, or any combination of suitable clauses, wherein the fresh cut plant or plant parts comprise one or more cut flowers.
78. The method of clause 77, any other suitable clause, or any combination of suitable clauses, wherein the flowers comprise roses.
79. The method of clause 77, any other suitable clause, or any combination of suitable clauses, wherein the flowers comprise chrysanthemums.
80. The method of clause 77, any other suitable clause, or any combination of suitable clauses, wherein the flowers comprise gladioli.
81. The method of clause 77, any other suitable clause, or any combination of suitable clauses, wherein the flowers comprise carnations.
82. The method of clause 66, any other suitable clause, or any combination of suitable clauses, wherein the plant or plant parts comprise one or more flower bulbs.
83. The method of clause 82, any other suitable clause, or any combination of suitable clauses, wherein the flower bulbs are selected from the group consisting of bulbs, corns, rhizomes, tubers, and any combination thereof.
84. The method of clause 66, any other suitable clause, or any combination of suitable clauses, wherein the environment comprising exogenous ethylene is an enclosed space or a partially enclosed space.
85. The method of clause 84, any other suitable clause, or any combination of suitable clauses, wherein the enclosed space/partially enclosed space is a refrigerator.
86. The method of clause 84, any other suitable clause, or any combination of suitable clauses, wherein the enclosed space/partially enclosed space is a household refrigerator.
87. The method of clause 84, any other suitable clause, or any combination of suitable clauses, wherein the enclosed space/partially enclosed space is an industrial distribution center refrigerator.
88. The method of clause 84, any other suitable clause, or any combination of suitable clauses, wherein the enclosed space/partially enclosed space is a retailor refrigerator.
89. The method of clause 84, any other suitable clause, or any combination of suitable clauses, wherein the enclosed space/partially enclosed space is a transport refrigerator.
90. The method of clause 84, any other suitable clause, or any combination of suitable clauses, wherein the composition comprising the cyclopropene is placed in the enclosed space/partially enclosed space.
91. The method of clause 66, any other suitable clause, or any combination of suitable clauses, wherein the exogenous ethylene is present in the environment via one or more items in the produce.
92. The method of clause 66, any other suitable clause, or any combination of suitable clauses, wherein the exogenous ethylene is present in the environment via a household item.
93. The method of clause 92, any other suitable clause, or any combination of suitable clauses, wherein the household item is a stove.
94. The method of clause 92, any other suitable clause, or any combination of suitable clauses, wherein the household item is a propane-containing composition.
95. The method of clause 66, any other suitable clause, or any combination of suitable clauses, wherein the cyclopropene is 1-MCP.
96. The method of clause 66, any other suitable clause, or any combination of suitable clauses, wherein the composition comprising the cyclopropene comprises an activated carbon.
97. The method of clause 66, any other suitable clause, or any combination of suitable clauses, wherein the composition comprising the cyclopropene comprises a metal organic framework.
98. The method of clause 66, any other suitable clause, or any combination of suitable clauses, wherein the composition comprising the cyclopropene comprises a molecular encapsulating agent.
99. The method of clause 66, any other suitable clause, or any combination of suitable clauses, wherein the composition comprising the cyclopropene comprises porous silica.
100. The method of clause 66, any other suitable clause, or any combination of suitable clauses, wherein the composition comprising the cyclopropene comprises a sachet.
101. The method of clause 66, any other suitable clause, or any combination of suitable clauses, wherein the composition comprising the cyclopropene comprises a film.
102. The method of clause 66, any other suitable clause, or any combination of suitable clauses, wherein the composition comprising the cyclopropene comprises a card.
103. The method of clause 66, any other suitable clause, or any combination of suitable clauses, wherein the composition comprising the cyclopropene comprises a card coated with the cyclopropene.
104. The method of clause 66, any other suitable clause, or any combination of suitable clauses, wherein the composition comprising the cyclopropene comprises a sticker.
105. The method of clause 66, any other suitable clause, or any combination of suitable clauses, wherein the composition comprising the cyclopropene comprises a sticker coated with the cyclopropene.
106. The method of clause 66, any other suitable clause, or any combination of suitable clauses, wherein the composition comprising the cyclopropene comprises an insert.
107. The method of clause 66, any other suitable clause, or any combination of suitable clauses, wherein the composition comprising the cyclopropene comprises an insert coated with the cyclopropene.
108. The method of clause 66, any other suitable clause, or any combination of suitable clauses, wherein the composition comprising the cyclopropene comprises a label.
109. The method of clause 66, any other suitable clause, or any combination of suitable clauses, wherein the composition comprising the cyclopropene comprises a label coated with the cyclopropene.
110. The method of clause 66, any other suitable clause, or any combination of suitable clauses, wherein the composition comprising the cyclopropene comprises a packaging.
111. The method of clause 66, any other suitable clause, or any combination of suitable clauses, wherein the composition comprising the cyclopropene comprises a packaging coated with the cyclopropene.
112. The method of clause 66, any other suitable clause, or any combination of suitable clauses, wherein the composition comprising the cyclopropene is configured to release the cyclopropene under humidity.
113. The method of clause 66, any other suitable clause, or any combination of suitable clauses, wherein the composition comprising the cyclopropene comprises a spray.
114. The method of clause 66, any other suitable clause, or any combination of suitable clauses, wherein the composition comprising the cyclopropene comprises an aerosol can.
115. The method of clause 66, any other suitable clause, or any combination of suitable clauses, wherein the composition comprising the cyclopropene comprises a caulk gun.
116. The method of clause 66, any other suitable clause, or any combination of suitable clauses, wherein the composition comprising the cyclopropene comprises a marker.
117. The method of clause 66, any other suitable clause, or any combination of suitable clauses, wherein the composition comprising the cyclopropene comprises a paint brush.
118. The method of clause 66, any other suitable clause, or any combination of suitable clauses, wherein the composition comprising the cyclopropene comprises a stick.
119. The method of clause 66, any other suitable clause, or any combination of suitable clauses, wherein the composition comprising the cyclopropene comprises a chalk.
120. The method of clause 66, any other suitable clause, or any combination of suitable clauses, wherein the composition comprising the cyclopropene comprises a bag.
121. The method of clause 66, any other suitable clause, or any combination of suitable clauses, wherein the composition comprising the cyclopropene comprises a can comprising a bladder, wherein the cyclopropene is present inside the bladder.
122. The method of clause 66, any other suitable clause, or any combination of suitable clauses, wherein the method is associated with an improved quality of the produce.
123. The method of clause 66, any other suitable clause, or any combination of suitable clauses, wherein the method is associated with a longer duration of freshness of the produce.
124. The method of clause 66, any other suitable clause, or any combination of suitable clauses, wherein the method is associated with a reduction of waste for the produce.
125. The method of clause 66, any other suitable clause, or any combination of suitable clauses, wherein the mixed type of produce comprises fresh produce and over-ripened and/or aged produce.
126. The method of clause 125, any other suitable clause, or any combination of suitable clauses, wherein the cyclopropene provides a preserving and/or extending quality of the fresh produce.
127. The method of clause 66, any other suitable clause, or any combination of suitable clauses, wherein the mixed type of produce comprises non-climacteric produce and climacteric produce.
128. The method of clause 127, any other suitable clause, or any combination of suitable clauses, wherein the cyclopropene provides a preserving and/or extending quality of the non-climacteric produce.
129. The method of clause 127, any other suitable clause, or any combination of suitable clauses, wherein the non-climacteric produce is fresh produce.
130. The method of clause 66, any other suitable clause, or any combination of suitable clauses, wherein the mixed type of produce comprises fresh produce and high ethylene-emitting produce.
131. The method of clause 130, any other suitable clause, or any combination of suitable clauses, wherein the cyclopropene provides a preserving and/or extending quality of the fresh produce.

Various embodiments of the invention are described herein as follows. In one aspect described herein, a method of treating a mixed type of produce is provided. The method comprises administering a composition comprising a cyclopropene to the mixed type of produce.

As used herein, a “mixed type of produce” refers to at least two items of produce, including a first item of produce and a second item of produce that are not the same. For instance, at least two different types of produce are included in a “mixed type of produce.”

In an embodiment, the mixed type of produce comprises produce is present in an enclosed space or a partially enclosed space. For instance, the enclosed space/partially enclosed space can be a refrigerator.

In an embodiment, the composition comprising the cyclopropene is placed in the enclosed space/partially enclosed space. Any delivery method or delivery system associated with delivery of cyclopropene can be utilized and several are described herein.

As used herein, a cyclopropene refers to any compound with the formula

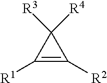

where each R¹, R², R³ and R⁴ is independently selected from the group consisting of H and a chemical group of the formula:

-(L)ₙ-Z

where n is an integer from 0 to 12. Each L is a bivalent radical. Suitable L groups include, for example, radicals containing one or more atoms selected from B, C, N, O, P, S, Si, or mixtures thereof. The atoms within an L group may be connected to each other by single bonds, double bonds, triple bonds, or mixtures thereof. Each L group may be linear, branched, cyclic, or a combination thereof. In any one R group (i.e., any one of R¹, R², R³ and R⁴) the total number of heteroatoms (i.e., atoms that are neither H nor C) is from 0 to 6. Independently, in any one R group the total number of non-hydrogen atoms is 50 or less. Each Z is a monovalent radical. Each Z is independently selected from the group consisting of a C₁-C₈ alkyl, hydrogen, halo, cyano, nitro, nitroso, azido, chlorate, bromate, iodate, isocyanato, isocyanido, isothiocyanato, pentafluorothio, and a chemical group G, wherein G is a 3- to 14-membered ring system.

The R¹, R², R³, and R⁴ groups are independently selected from the suitable groups. Among the groups that are suitable for use as one or more of R¹, R², R³, and R⁴ are, for example, aliphatic groups, aliphatic-oxy groups, alkylphosphonato groups, cycloaliphatic groups, cycloalkylsulfonyl groups, cycloalkylamino groups, heterocyclic groups, aryl groups, heteroaryl groups, halogens, silyl groups, and mixtures and combinations thereof. Groups that are suitable for use as one or more of R¹, R², R³, and R⁴ may be substituted or unsubstituted.

Among the suitable R¹, R², R³, and R⁴ groups are, for example, aliphatic groups. Some suitable aliphatic groups include, for example, alkyl, alkenyl, and alkynyl groups. Suitable aliphatic groups may be linear, branched, cyclic, or a combination thereof. Independently, suitable aliphatic groups may be substituted or unsubstituted.

As used herein, a chemical group of interest is said to be “substituted” if one or more hydrogen atoms of the chemical group of interest is replaced by a substituent.

Also among the suitable R¹, R², R³, and R⁴ groups are, for example, substituted and unsubstituted heterocyclyl groups that are connected to the cyclopropene compound through an intervening oxy group, amino group, carbonyl group, or sulfonyl group; examples of such R¹, R², R³, and R⁴ groups are heterocyclyloxy, heterocyclylcarbonyl, diheterocyclylamino, and diheterocyclylaminosulfonyl.

Also among the suitable R¹, R², R³, and R⁴ groups are, for example, substituted and unsubstituted heterocyclic groups that are connected to the cyclopropene compound through an intervening oxy group, amino group, carbonyl group, sulfonyl group, thioalkyl group, or aminosulfonyl group; examples of such R¹, R², R³, and R⁴ groups are diheteroarylamino, heteroarylthioalkyl, and diheteroarylaminosulfonyl.

Also among the suitable R¹, R², R³, and R⁴ groups are, for example, hydrogen, fluoro, chloro, bromo, iodo, cyano, nitro, nitroso, azido, chlorate, bromate, iodate, isocyanato, isocyanido, isothiocyanato, pentafluorothio, acetoxy, carboethoxy, cyanato, nitrato, nitrito, perchlorato, allenyl, butylmercapto, diethylphosphonato, dimethylphenylsilyl, isoquinolyl, mercapto, naphthyl, phenoxy, phenyl, piperidino, pyridyl, quinolyl, triethylsilyl, trimethylsilyl, and substituted analogs thereof.

As used herein, the chemical group G is a 3- to 14-membered ring system. Ring systems suitable as chemical group G may be substituted or unsubstituted; they may be aromatic (including, for example, phenyl and naphthyl) or aliphatic (including unsaturated aliphatic, partially saturated aliphatic, or saturated aliphatic); and they may be carbocyclic or heterocyclic. Among heterocyclic G groups, some suitable heteroatoms are, for example, nitrogen, sulfur, oxygen, and combinations thereof. Ring systems suitable as chemical group G may be monocyclic, bicyclic, tricyclic, polycyclic, spiro, or fused; among suitable chemical group G ring systems that are bicyclic, tricyclic, or fused, the various rings in a single chemical group G may be all the same type or may be of two or more types (for example, an aromatic ring may be fused with an aliphatic ring).

In one embodiment, one or more of R¹, R², R³, and R⁴ is hydrogen or C₁-C₁₀ alkyl. In another embodiment, each of R¹, R², R³, and R⁴ is hydrogen or a C₁-C₈ alkyl. In another embodiment, each of R¹, R², R³, and R⁴ is hydrogen or C₁-C₄ alkyl. In another embodiment, each of R¹, R², R³, and R⁴ is hydrogen or methyl. In another embodiment, R¹ is C₁-C₄ alkyl and each of R², R³, and R⁴ is hydrogen. In another embodiment, R¹ is methyl and each of R², R³, and R⁴ is hydrogen, and the cyclopropene compound is known herein as 1-methylcyclopropene or “1-MCP.”

In various embodiments, the cyclopropene is of the formula:

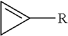

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy. In one embodiment, R is C₁-C₈ alkyl. In another embodiment, R is methyl.

In another embodiment, the cyclopropene is of the formula:

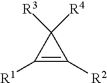

wherein R¹ is a substituted or unsubstituted C₁-C₄ alkyl, C₂-C₄ alkenyl, C₂-C₄ alkynyl, C₃-C₆ cycloalkyl, cycloalkylalkyl, phenyl, or naphthyl group; and R², R³, and R⁴ are hydrogen. In another embodiment, the cyclopropene comprises 1-methylcyclopropene (1-MCP).

In one embodiment, the cyclopropene comprises 1-methylcyclopropene (1-MCP). The cyclopropenes applicable to this invention may be prepared by any method. Some suitable methods of preparation of cyclopropenes are the processes disclosed in U.S. Pat. Nos. 5,518,988 and 6,017,849, herein incorporated by reference in their entirety.

In another aspect of the present disclosure, a method of treating plant or plant parts in an environment comprising exogenous ethylene is provided. The method comprises administering a composition comprising a cyclopropene to the produce. The previously described embodiments of the method of treating a mixed type of produce are applicable to the method of treating plant or plant parts in an environment comprising exogenous ethylene described herein.

### Example 1

### Administration of Cyclopropene to a Mixed Type of Produce

Treatment of a mixed type of produce with and within a cyclopropene can be evaluated. For the instant example, 1-MCP can be utilized as the exemplary cyclopropene. Any of the described delivery methods can be utilized according to the instant example. Likewise, any of the described produce can comprise the mixed type of produce for the instant example.

Four groups can be utilized for the instant example, with each group including Subset A that is treated with 1-MCP and Subset B that is not treated with 1-MCP. For groups 1, 2, and 3, a single type of produce can be tested in each group. As an exemplary example, Group 1 can include apples alone, Group 2 can include pears alone, and Group 3 can include blueberries alone. Then, Group 4 can include a mixed type of the three types of produce together (e.g., apples, pears, and blueberries).

The four groups can be described as follows:

| Group | Subset | Components of Enclosed Space |
|---|---|---|
| 1 | A: Treated with 1-MCP | Individual Produce #1 alone |
| 1 | B: Not Treated with 1-MCP | Individual Produce #1 alone |
| 2 | A: Treated with 1-MCP | Individual Produce #2 alone |
| 2 | B: Not Treated with 1-MCP | Individual Produce #2 alone |
| 3 | A: Treated with 1-MCP | Individual Produce #3 alone |
| 3 | B: Not Treated with 1-MCP | Individual Produce #3 alone |
| 4 | A: Treated with 1-MCP | Mixed Type of Produce #1, |
| | | Produce #2, and Produce #3 |
| 4 | B: Not Treated with 1-MCP | Mixed Type of Produce #1, |
| | | Produce #2, and Produce #3 |

### Example 2

### Administration of Cyclopropene to Produce in the Presence of Exogenous Ethylene

Treatment of a produce in the presence of exogenous ethylene with and within a cyclopropene can be evaluated. For the instant example, 1-MCP can be utilized as the exemplary cyclopropene. Any of the described delivery methods can be utilized according to the instant example. Likewise, any of the described produce can comprise the mixed type of produce for the instant example.

Four groups can be utilized for the instant example:

| Group | 1-MCP | Components of Enclosed Space |
|---|---|---|
| 1 | Treated with 1-MCP | i) a single produce type and ii) a |
| | | known source of exogenous ethylene |
| 2 | Not Treated with 1-MCP | i) a single produce type and ii) a |
| | | known source of exogenous ethylene |
| 3 | Treated with 1-MCP | i) a mixed type of produce and ii) a |
| | | known source of exogenous ethylene |
| 4 | Not Treated with 1-MCP | i) a mixed type of produce and ii) a |
| | | known source of exogenous ethylene |

### Example 3

### Ethylene Characteristics of Various Types of Produce

Different types of produce have varying ethylene properties. For instance, different types of produce can produce endogenous ethylene at various rates. Furthermore, different types of produce have varying sensitivity to exogenous ethylene, thus influencing the degree of ripening (e.g., freshness) of the produce when it is exposed to ethylene.

The following table lists various types of produce and their associated i) production of endogenous ethylene, ii) sensitivity to exogenous ethylene, and iii) responsiveness to 1-MCP. For production of endogenous ethylene, each type of produce is identified as very low production (“VL”), low production (“L”), medium production (“M”), high production (“H”), and very high production (“VH”), if such values are known. For sensitivity to exogenous ethylene, each type of produce is identified as low sensitivity (“L”), medium sensitivity (“M”), or high sensitivity (“H”), if such values are known. For responsiveness to 1-MCP, each type of produce is identified as low sensitivity (“L”), medium sensitivity (“M”), or high sensitivity (“H”), if such values are known.

| | | Endogenous | Exogenous | |
|---|---|---|---|---|
| | Produce | Ethylene | Ethylene | 1-MCP |
| Produce | Type | Production | Sensitivity | Responsiveness |
| Apple | Fruit | VH | H | H |
| Apricot | Fruit | M | M | M |
| Artichoke | Vegetable | L | L | L |
| Asparagus | Vegetable | VL | M | L |
| Avocado | Fruit | H | H | H |
| Banana | Fruit | M | H | H |
| Blackberry | Fruit | L | L | L |
| Blueberry | Fruit | L | L | L |
| Broccoli | Vegetable | VL | H | H |
| Cantaloupe | Fruit | H | M | M |
| Carrot | Vegetable | VL | H | M |
| Cauliflower | Vegetable | VL | H | |
| Celery | Vegetable | VL | M | |
| Cherimoya | Fruit | H | H | H |
| Cherry | Fruit | VL | L | L |
| Cucumber | Vegetable | L | H | L |
| Eggplant | Vegetable | L | M | |
| Fig | Fruit | M | L | L |
| Grape | Fruit | VL | L | L |
| Grapefruit | Fruit | VL | M | L |
| Guava | Fruit | L | M | H |
| Honeydew | Fruit | M | H | |
| Kiwifruit | Fruit | L | H | H |
| Lemon | Fruit | VL | M | |
| Lettuce | Vegetable | VL | H | M |
| Lime | Fruit | VL | M | L |
| Mango | Fruit | M | M | H |
| Mushroom | Vegetable | VL | M | |
| Nectarine | Fruit | M | M | M |
| Onion | Vegetable | VL | L | |
| Orange | Fruit | VL | M | L |
| Papaya | Fruit | M | M | H |
| Peach | Fruit | M | M | M |
| Pear | Fruit | H | H | H |
| Pepper, Bell | Vegetable | L | L | M |
| Pepper, Chili | Vegetable | L | M | |
| Persimmon | Fruit | L | H | H |
| Pineapple | Fruit | L | L | L |
| Plum | Fruit | M | M | H |
| Pomegranate | Fruit | VL | L | M |
| Potato | Vegetable | VL | M | M |
| Pumpkin | Vegetable | L | M | |
| Radish | Vegetable | VL | L | |
| Snap Bean | Vegetable | L | M | |
| Spinach | Vegetable | VL | H | |
| Squash | Vegetable | L | M | M |
| Strawberry | Fruit | L | L | L |
| Sweet Corn | Vegetable | VL | L | |
| Tomato (MG) | Vegetable | VL | H | H |
| Tomato (Ripe) | Vegetable | H | L | M |
| Watermelon | Fruit | VL | H | M |

### Example 4

### Ethylene Characteristics of Various Types of Produce

Different types of produce have varying ethylene properties. For instance, different types of produce can produce endogenous ethylene at various rates. Furthermore, different types of produce have varying sensitivity to exogenous ethylene, thus influencing the degree of ripening (e.g., freshness) of the produce when it is exposed to ethylene.

The following table lists various types of produce or plant/plant part and their associated i) production of endogenous ethylene and ii) sensitivity to exogenous ethylene. For production of endogenous ethylene, each type of produce is identified as very low production (“VL”), low production (“L”), medium production (“M”), high production (“H”), and very high production (“VH”), if such values are known. For sensitivity to exogenous ethylene, each type of produce is identified as low sensitivity (“L”), medium sensitivity (“M”), or high sensitivity (“H”), if such values are known.

| | Endogenous | Exogenous |
|---|---|---|
| | Ethylene | Ethylene |
| Produce/Plant/Plant Part | Production | Sensitivity |
| Apple (non-chilled) | VH | H |
| Apple (chilled) | VH | H |
| Apricot | H | H |
| Artichoke-Globe/Jerusalem | VL | L |
| Asian Pear | H | H |
| Asparagus | VL | M |
| Avocado - California | H | H |
| Tropical | H | H |
| Banana | M | H |
| Beans - Lima | L | M |
| Snap/Green | L | M |
| Belgian Endive | VL | M |
| Berries - Blackberry | L | L |
| Blueberry | L | L |
| Cranberry | L | L |
| Currents | L | L |
| Dewberry | L | L |
| Elderberry | L | L |
| Gooseberry | L | L |
| Loganberry | L | L |
| Raspberry | L | L |
| Strawberry | L | L |
| Breadfruit | M | M |
| Broccoli | VL | H |
| Brussel Sprouts | VL | H |
| Cabbage | VL | H |
| Cantaloupe | H | M |
| Cape Gooseberry | L | L |
| Carrots - topped | VL | L |
| Casaba Melon | L | L |
| Cauliflower | VL | H |
| Celery | VL | M |
| Chard | VL | H |
| Cherimoya | VH | H |
| Cherry - Sour | VL | L |
| Sweet | VL | L |
| Chicory | VL | LH |
| Chinese Gooseberry | L | H |
| Collards | VL | M |
| Crenshaw Melon | M | H |
| Cucumbers | L | H |
| Eggplant | L | L |
| Endive (Escarole) | VL | M |
| Feijoa | M | L |
| Figs | M | L |
| Garlic | VL | L |
| Ginger | VL | L |
| Grapefruit - AZ/CA/FL/TX | VL | L |
| Grapes | VL | L |
| Greens | VL | H |
| Guava | L | M |
| Honeydew | M | H |
| Horseradish | VL | L |
| Jack Fruit | M | M |
| Kale | VL | M |
| Kiwi Fruit | L | H |
| Kohirabi | VL | L |
| Leeks | VL | M |
| Lemon | VL | M |
| Lettuce - Butterhead | L | M |
| Head/Iceberg | VL | H |
| Lime | VL | M |
| Lychee | M | M |
| Mandarine | VL | M |
| Mango | M | H |
| Mangosteen | M | H |
| Mincola | L | L |
| Mushrooms | L | M |
| Nectarine | H | H |
| Okra | L | H |
| Olive | L | M |
| Onions - Dry | VL | L |
| Green | VL | M |
| Orange - CA/AZ | VL | M |
| FL/TX | VL | M |
| Papaya | H | H |
| Paprika | L | L |
| Parsley | VL | H |
| Parsnip | VL | L |
| Passion Fruit | VH | H |
| Peach | H | H |
| Pear - Anjou/Bartlett/Bose | H | H |
| Prickley | N | L |
| Peas | VL | M |
| Pepper - Bell (Sweet) | L | L |
| Chili | L | L |
| Persian Melon | M | H |
| Persimmon - Fuyo | L | H |
| Hachiya | L | H |
| Pineapple | L | L |
| Guava | M | L |
| Plantain | L | H |
| Plum/Prune | M | H |
| Pomegranate | L | L |
| Potato - Processing | VL | M |
| Seed | VL | M |
| Table | VL | M |
| Pumpkin | L | L |
| Quince | L | H |
| Radishes | VL | L |
| Red Beet | VL | L |
| Rambutan | H | H |
| Rhubarb | VL | L |
| Rutabaga | VL | L |
| Sapota | VH | H |
| Spinach | VL | H |
| Squash - Hard Skin | L | L |
| Soft Skin | L | M |
| Summer | L | M |
| Zucchini | N | N |
| Star Fruit | L | L |
| Swede (Rutabaga) | VL | L |
| Sweet Corn | VL | L |
| Sweet Potato | VL | L |
| Tamarillo | L | M |
| Tangerine | VL | M |
| Taro Root | N | N |
| Tomato - Mature/Green | VL | H |
| Brkr/Lt. Pink | M | H |
| Tree - Tomato | H | M |
| Turnip - Roots | VL | L |
| Greens | VL | H |
| Watercress | VL | H |
| Watermelon | L | H |
| Yam | VL | L |
| Live Plants | | |
| Cut Flowers - Roses | VL | H |
| Cut Flowers - | VL | H |
| Chrysanthemums | | |
| Cut Flowers - Gladioli | VL | H |
| Carnations | VL | H |
| Potted Plants | VL | H |
| Nursery Stock | VL | H |
| Christmas Trees | N | N |
| Flower Bulbs - Bulbs/Corns | VL | H |
| Flower Bulbs - Rhizomes/Tubers | VL | H |

### Example 5

### Analyses of Various Compositions Comprising Cyclopropene

For Examples 6-24, several composition comprising cyclopropene were evaluated for effectiveness on various types of produce or plant/plant parts. For instance, the following exemplary compositions were evaluated:

| | | Percentage of |
|---|---|---|
| Composition | Description | Cyclopropene |
| Formulation A | A sheet of business cards (5.08 cm × 8.89 cm) coated with | 1.13% |
| | a 1.13% aqueous 1-MCP treatment. Cards were | |
| | individually separated for application | |
| Formulation B | A sheet of adhesive stickers (2.54 cm × 7.62 cm) coated | 1.13% |
| | with a 1.13% aqueous 1-MCP treatment. Stickers were | |
| | removed from the backer sheet for application | |
| Formulation C | A dilute (0.031%) aqueous 1-MCP treatment, applied via | 0.031% |
| | pump spray bottle | |
| Formulation D | Dipped teabag, containing 0.014% 1-MCP encapsulated in | 0.014% |
| | a solid, into water | |
| Formulation E | A concentrated (1.3%) aqueous 1-MCP treatment applied | 1.3% |
| | by dropper | |

### Example 6

### Evaluation of Bananas—Formulation D

Bananas were placed in a gas tight 35.4 L plastic chamber with 1 unit of 1-MCP Formulation D supplying 0.0875 mg 1-MCP. The control bananas were placed in a gas tight 35.4 L plastic chamber with a small amount of water in a container. The test was conducted at room temperature. The doors were set ajar the next day.

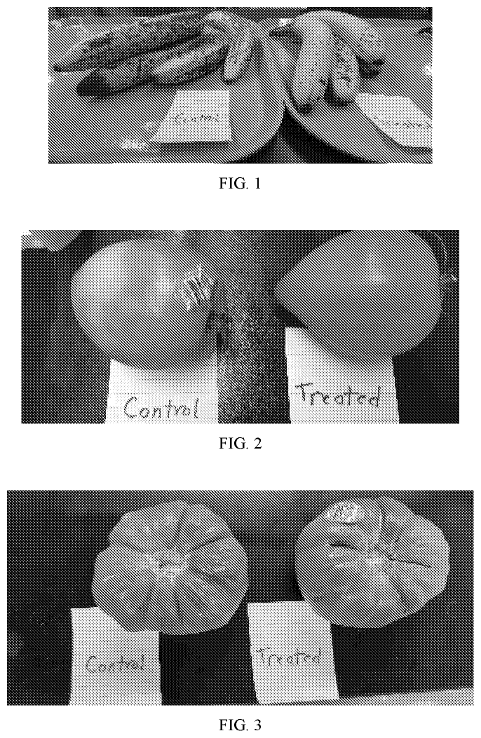

FIG. 1 shows an evaluation performed on day 6 comparing the 1-MCP treated versus the control bananas.

### Example 7

### Evaluation of Tomatoes—Formulation D

Tomato variety one was placed in a gas tight 6 L plastic chamber with 1 unit of 1-MCP Formulation D supplying 0.0875 mg 1-MCP. The control tomato was placed in a gas tight 6 L plastic chamber with a small amount of water in a container. The test was conducted at 5° C. The chamber was left closed until evaluation on day 10.

FIG. 2 shows an evaluation performed on day 10 comparing the 1-MCP treated versus the control tomatoes. Additionally, the tomatoes were handled and the control tomato was observed to be softer than the treated tomato.

### Example 8

### Evaluation of Tomatoes—Formulation D

Tomato variety two was placed in a gas tight 6 L plastic chamber with 1 unit of 1-MCP Formulation D supplying 0.0875 mg 1-MCP. The control tomato was placed in a gas tight 6 L plastic chamber with a small amount of water in a container. The test was conducted at 5° C. The chamber was left closed until evaluation on day 10.

FIG. 3 shows an evaluation performed on day 10 comparing the 1-MCP treated versus the control tomatoes. Additionally, the tomatoes were handled and the control tomato was observed to be softer than the treated tomato.

### Example 9

### Evaluation of Avocados—Formulation A

Avocados were placed in a gas tight 6 L plastic chamber with 1 unit of 1-MCP Formulation A supplying 2.65 mg 1-MCP. The control avocados were placed in a gas tight 6 L plastic chamber. Each chamber received 1 ml of water in a container. The test was conducted at room temperature. The doors were set ajar the next day.

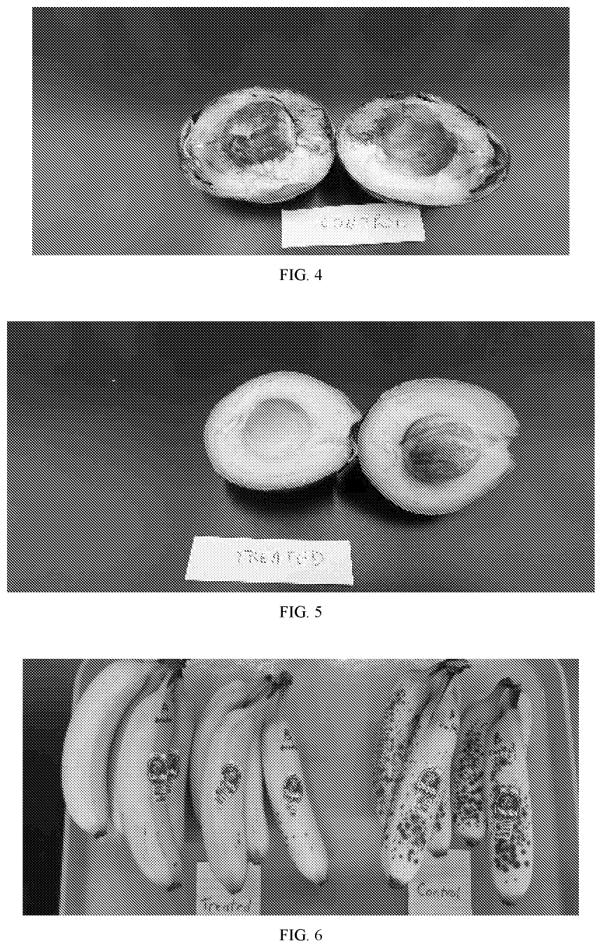

FIGS. 4 and 5 show an evaluation performed on day 7 comparing the 1-MCP treated versus the control avocados. Additionally, firmness testing showed that the treated avocados were on average 6 times firmer than the control avocados.

### Example 10

### Evaluation of Bananas—Formulation A

Bananas were placed in a gas tight 35.4 L plastic chamber with 1 unit of 1-MCP Formulation A supplying 2.65 mg 1-MCP. The control bananas were placed in a gas tight 35.4 L plastic chamber. Each chamber received 1 ml of water in a container. The test was conducted at room temperature. The doors were set ajar the next day.

FIG. 6 shows an evaluation performed on day 7 comparing the 1-MCP treated versus the control bananas. Additionally, firmness testing showed that the treated bananas were on average 1.2 times firmer than the control bananas.

### Example 11

### Evaluation of Green Bell Peppers and Papayas—Formulation A

Green bell peppers and papayas were placed in a gas tight 35.4 L plastic chamber with 1 unit of 1-MCP Formulation A supplying 2.65 mg 1-MCP. The control green bell peppers and papayas were placed in a gas tight 35.4 L plastic chamber. Each chamber received 1 ml of water in a container. The test was conducted at room temperature. The doors were opened at evaluation on day 8.

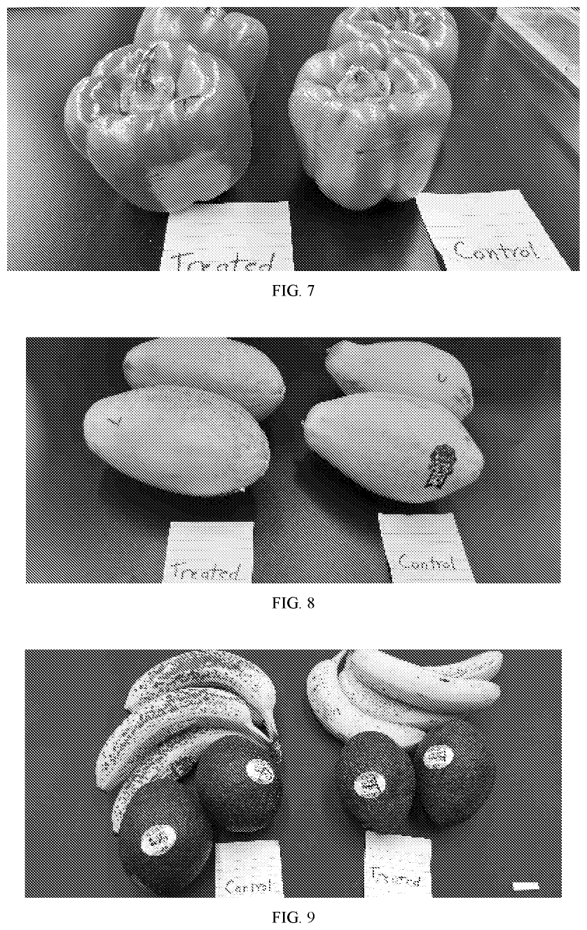

FIGS. 7 and 8 show evaluations comparing the 1-MCP treated versus the control green bell peppers and papayas, respectively. The control green bell peppers were observed to show wrinkling, and the control papayas were observed to show less green color remaining.

### Example 12

### Evaluation of Bananas and Avocados—Formulation D

Bananas and avocados were placed in a gas tight 35.4 L plastic chamber with 2 units of 1-MCP Formulation D supplying 0.175 mg 1-MCP. The control bananas and avocados were placed in a gas tight 35.4 L plastic chamber with a small amount of water in a container. The test was conducted at room temperature. The doors were opened the next day.

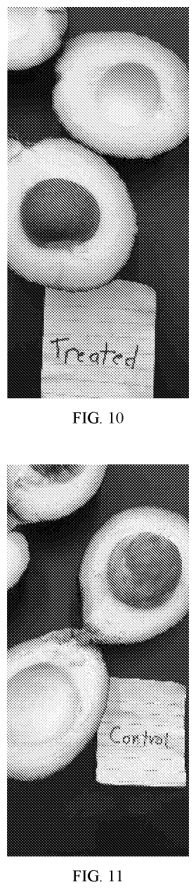

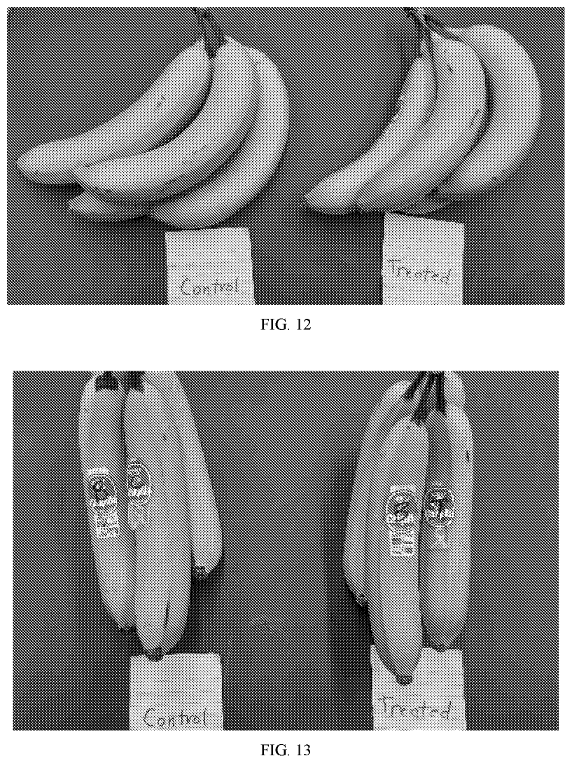

FIG. 9 shows an evaluation performed on day 6 comparing the 1-MCP treated versus the control bananas and avocados. FIGS. 10 and 11 show a second evaluation performed on day 8 comparing the internal condition of the 1-MCP treated avocados (FIG. 10) versus control avocados (FIG. 11). It was observed that the control avocados show more advanced ripening around their outer edges.

### Example 13

### Evaluation of Bananas—Formulation A

Bananas were placed in a gas tight 6 L plastic chamber with 1 unit of 1-MCP Formulation A supplying 2.65 mg 1-MCP. 25% of the surface area of the top 5 sides was left open at the top of the chamber. The control bananas were placed in a gas tight 6 L plastic chamber. Each chamber received 1 ml of water in a container. The test was conducted at room temperature. The chambers were opened the next day.

FIG. 12 shows an evaluation performed on day 17 comparing the 1-MCP treated versus the control bananas. FIG. 13 shows an evaluation performed on day 21 comparing the 1-MCP treated versus the control bananas.

### Example 14

### Evaluation of Bananas—Formulation B

Bananas were placed in a gas tight 35.4 L plastic chamber with 1 unit of 1-MCP Formulation B divided in fourths supplying 0.026 mg 1-MCP to each banana. The control bananas were placed in a gas tight 35.4 L plastic chamber. Each chamber received 1 ml of water in a container. The test was conducted at room temperature. The chambers were opened the next day.

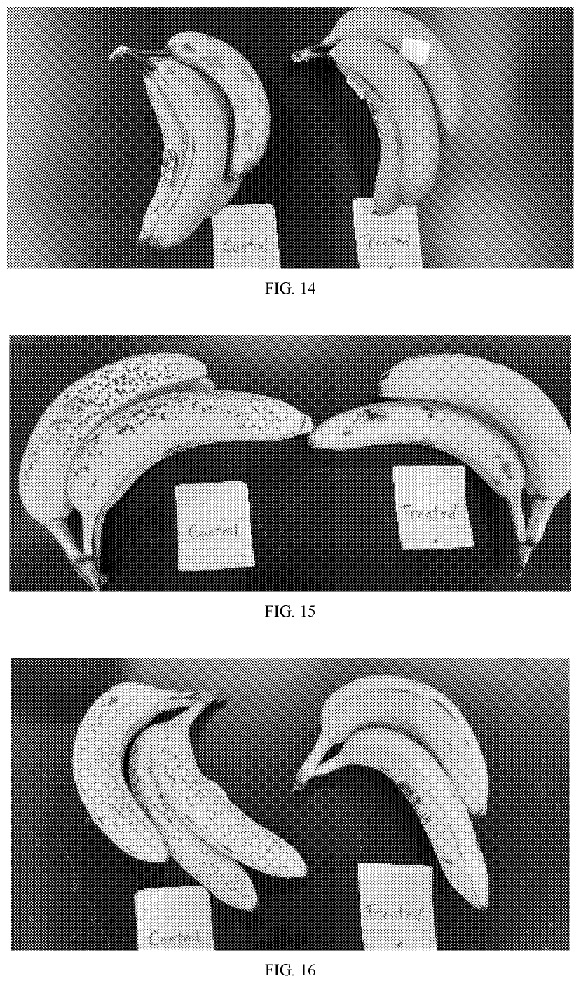

FIG. 14 shows an evaluation performed on day 14 comparing the 1-MCP treated versus the control bananas.

### Example 15

### Evaluation of Bananas—Formulation A

Bananas were placed in a gas tight 6 L plastic chamber with a 90-minute half-life with 1 unit of 1-MCP Formulation A supplying 2.65 mg 1-MCP. The control bananas were placed in a gas tight 6 L plastic chamber. Each chamber received 1 ml of water in a container. The test was conducted at room temperature. The chambers were opened the next day.

FIG. 15 shows an evaluation performed on day 7 comparing the 1-MCP treated versus the control bananas.

### Example 16

### Evaluation of Bananas—Formulation C

Bananas were placed in a gas tight 6 L plastic chamber with 1.97 g of 1-MCP Formulation C directly onto the bananas supplying 0.590 mg 1-MCP. The control bananas were placed in a gas tight 6 L plastic chamber with 1 ml of water in a container. The test was conducted at room temperature. The chambers were opened the next day.

FIG. 16 shows an evaluation performed on day 6 comparing the 1-MCP treated versus the control bananas.

### Example 17

### Evaluation of Pears, Strawberries, Apples, and Mangos—Formulation D

Cut-up pears, strawberries, apples, and mangos were placed in a gas tight 6 L plastic chamber with 2 units of 1-MCP Formulation D supplying 0.175 mg 1-MCP. The control cut up pears, strawberries, apples and mangos were placed in a gas tight 6 L plastic chamber with a small amount of water in a container. The test was conducted at room temperature. The chambers were opened on day 2.

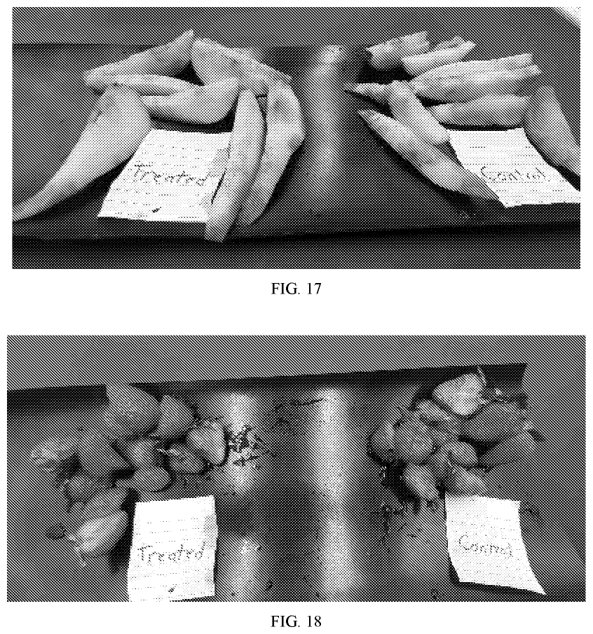

FIGS. 17 and 18 show an evaluation performed on day 2 comparing the 1-MCP treated fruit versus the control fruit. FIG. 17 compares the pears and FIG. 18 compares the strawberries. Both the control pears and the control strawberries were observed to have a softer feel/texture compared to the 1-MCP treated fruit. The control strawberries were also observed to release more moisture than the 1-MCP treated fruit.

### Example 18

### Evaluation of Lettuce, Cauliflower, and Broccoli—Formulation D

Cut-up lettuce, cauliflower, and broccoli were placed in a gas tight 6 L plastic chamber with 2 units of 1-MCP Formulation D supplying 0.175 mg 1-MCP. The control cut up lettuce, cauliflower and broccoli were placed in a gas tight 6 L plastic chamber with a small amount of water in a container. The test was conducted at room temperature. The chambers were opened on day 4.

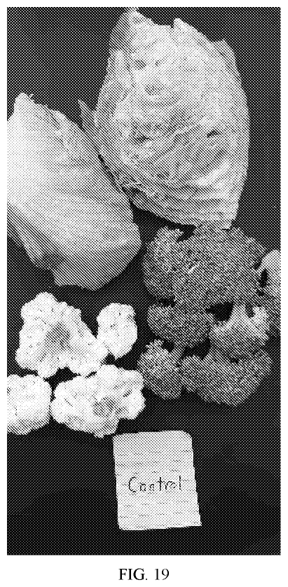

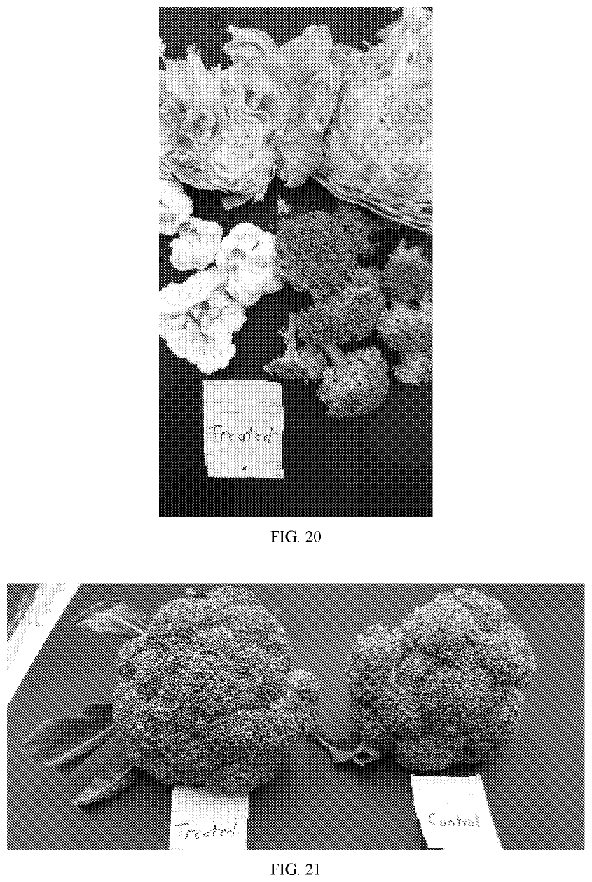

FIGS. 19 and 20 show an evaluation performed on day 4 comparing the 1-MCP treated produce versus the control produce. FIG. 19 shows the control produce and FIG. 20 shows the 1-MCP treated produce.

### Example 19

### Evaluation of Broccoli, Blueberries, and Kiwi—Formulation A

Broccoli, blueberries, and kiwi were placed in a gas tight 35.4 L plastic chamber with 2 units of 1-MCP Formulation A supplying 5.30 mg 1-MCP. The control broccoli, blueberries and kiwi were placed in a gas tight 35.4 L plastic chamber. Each chamber received 1 ml of water in a container. The test was conducted at room temperature. The doors were opened the next day.

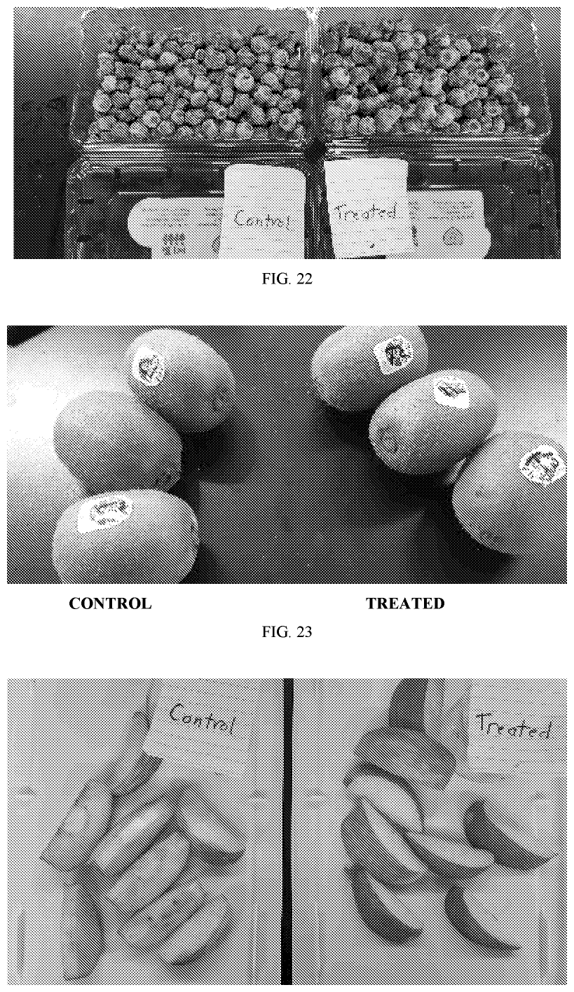

FIG. 21 shows an evaluation performed on day 2 comparing the 1-MCP treated versus the control broccoli. FIGS. 22 and 23 show results of a second evaluation performed on day 10 comparing the 1-MCP treated versus the control blueberries and kiwi, respectively. At day 7, the 1-MCP treated blueberries retained 5% more weight than the control blueberries. At day 10, the 1-MCP treated blueberries were on average 26% firmer than the control and 1-MCP treated kiwi 12% firmer than control blueberries.

### Example 20

### Evaluation of Apples—Formulation D

Sliced apples were placed in a gas tight 6 L plastic chamber with 2 units of 1-MCP Formulation D supplying 0.175 mg 1-MCP. The sliced apples were placed in a gas tight 6 L plastic chamber with a small amount of water in a container. The test was conducted at room temperature.

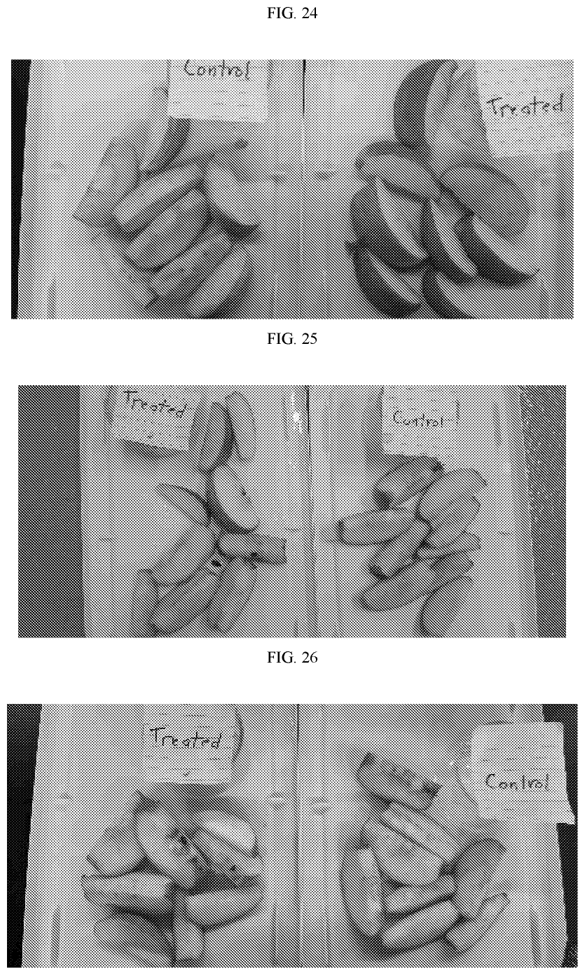

FIG. 24 shows an evaluation performed on day 2 comparing the 1-MCP treated versus the control apples. FIG. 25 shows an evaluation performed on day 6 comparing the 1-MCP treated versus the control apples.

### Example 21

### Evaluation of Apples—Formulation D

Sliced apples were placed in a gas tight 6 L plastic chamber with 2 units of 1-MCP Formulation D supplying 0.175 mg 1-MCP. The sliced apples were placed in a gas tight 6 L plastic chamber with a small amount of water in a container. The test was conducted at 5° C.

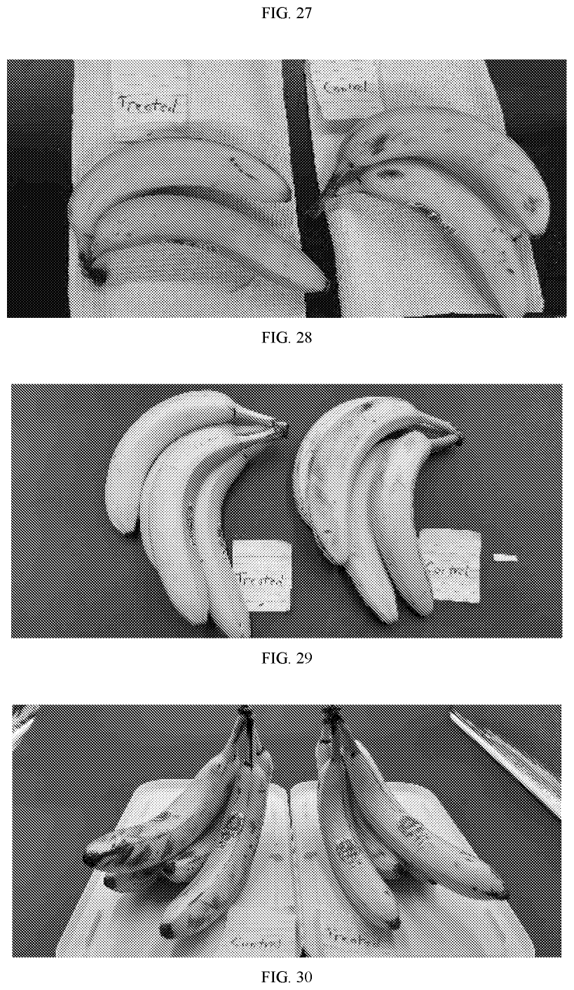

FIG. 26 shows an evaluation performed on day 1 comparing the 1-MCP treated versus the control apples. FIG. 27 shows an evaluation performed on day 6 comparing the 1-MCP treated versus the control apples.

### Example 22

### Evaluation of Bananas—Formulation E

Bananas were placed in a gas tight 6 L plastic chamber with Formulation E applied onto a liner under the bananas supplying 2.73 mg 1-MCP. The control bananas were placed on a liner in a gas tight 6 L plastic chamber. Each chamber received 1 ml of water onto the liner. The test was conducted at room temperature. The chambers were opened the next day.

FIG. 28 shows an evaluation performed on day 9 comparing the 1-MCP treated versus the control bananas.

### Example 23

### Evaluation of Bananas—Formulation C

Bananas were placed in a gas tight 6 L plastic chamber with Formulation C applied directly onto the chamber floor supplying 1.03 mg 1-MCP. The control bananas were in a gas tight 6 L plastic chamber with 1 ml of water. The test was conducted at room temperature. The chambers were opened the next day.

FIG. 29 shows an evaluation performed on day 4 comparing the 1-MCP treated versus the control bananas. FIG. 30 shows an evaluation performed on day 7 comparing the 1-MCP treated versus the control bananas.

### Example 24

### Evaluation of Bananas—Formulation C

Bananas were placed in a gas tight 6 L plastic chamber with Formulation C applied onto a liner under the bananas supplying 0.964 mg 1-MCP. The control bananas were placed on a liner in a gas tight 6 L plastic chamber with 1 ml of water applied onto the liner. The test was conducted at room temperature. The chambers were opened the next day.

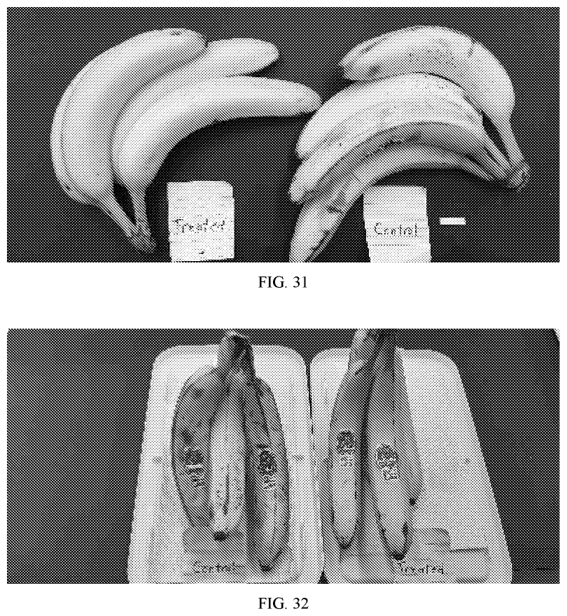

FIG. 31 shows an evaluation performed on day 4 comparing the 1-MCP treated versus the control bananas. FIG. 32 shows an evaluation performed on day 7 comparing the 1-MCP treated versus the control bananas.

1. A method of treating a mixed type of produce, said method comprising the step of administering a composition comprising a cyclopropene to the mixed type of produce.

2. (canceled)

3. (canceled)

4. (canceled)

5. The method of claim 1, wherein the mixed type of produce comprises fresh cut produce, sliced produce, ready-to-eat produce, read-to-serve produce, or any combination thereof.

6. The method of claim 1, wherein the mixed type of produce comprises a fresh cut plant or plant parts.

7. The method of claim 6, wherein the fresh cut plant or plant parts comprise a Christmas tree.

8. The method of claim 6, wherein the fresh cut plant or plant parts comprise one or more cut flowers.

9. The method of claim 1, wherein the mixed type of produce comprises produce is present in an enclosed space or a partially enclosed space.

10. The method of claim 9, wherein the enclosed space/partially enclosed space is a refrigerator.

11. The method of claim 9, wherein the enclosed space/partially enclosed space is a household refrigerator.

12. The method of claim 9, wherein the enclosed space/partially enclosed space is an industrial distribution center refrigerator.

13. (canceled)

14. (canceled)

15. (canceled)

16. (canceled)

17. (canceled)

18. (canceled)

19. (canceled)

20. (canceled)

21. The method of claim 1, wherein the composition comprising the cyclopropene comprises a sachet.

22. The method of claim 1, wherein the composition comprising the cyclopropene comprises a film.

23. The method of claim 1, wherein the composition comprising the cyclopropene comprises a card.

24. The method of claim 1, wherein the composition comprising the cyclopropene comprises a card coated with the cyclopropene.

25. The method of claim 1, wherein the composition comprising the cyclopropene comprises a sticker.

26. The method of claim 1, wherein the composition comprising the cyclopropene comprises a sticker coated with the cyclopropene.

27. The method of claim 1, wherein the composition comprising the cyclopropene comprises an insert.

28. The method of claim 1, wherein the composition comprising the cyclopropene comprises an insert coated with the cyclopropene.

29. The method of claim 1, wherein the composition comprising the cyclopropene comprises a label.

30. The method of claim 1, wherein the composition comprising the cyclopropene comprises a label coated with the cyclopropene.

31. (canceled)

32. (canceled)

33. The method of claim 1, wherein the method is associated with an improved quality of the mixed type of produce.

34.-39. (canceled)
